(19) United States
(12) Patent Application Publication
(10) Pub. No.: US 2004/0094256 A1
(43) Pub. Date: May 20, 2004

(54) Method for forming foamable boards

(76) Inventor: Jui Yang Chang, Taichung (TW)

Correspondence Address: Jui Yan CHANG, P.O.Box 63-298, Taichung, 406, TW

(21) Appl. No.: 10/672,987

(22) Filed: Sep. 25, 2003

Related U.S. Application Data
(63) Continuation-in-part of application No. 10/298,002, filed on Nov. 18, 2002, now Pat. No. 6,712,372.

(51) Int. Cl. B32B 31/14

(52) U.S. Cl. 156/78

(57) ABSTRACT

A method for forming boards of foamable materials, includes preparing and heating two plastic materials and a foamable material which is disposed between the plastic materials. The plastic materials and the foamable material are then squeezedto form a board having two outer layers formed by the plastic materials, and an intermediate layer formed by the foamable material. An air or a foamable agent may be injected into the foamable material before conducting the squeezing process, in order to decrease the density and the weight of the foamable material and the boards. The air may be selectable from carbon dioxide, propane, or butane, or the like

The present application is a continuation-in-part of U.S. patent application Ser. No. 10/298,002, filed 04 Nov. 2002, pending.

### BACKGROUND OF THE INVENTION

1. Field of the Invention

The present invention relates to a method, and more particularly to a method for forming boards of foamable materials and/or plastic materials.

2. Description of the Prior Art

Typical plastic plates or boards have been widely used for making various kinds of objects, such as files, albums, various casings, suitcases, luggage members, packaging materials for food or the like, decorative materials for vehicles, architecture materials, sports exercisers, etc.

Normally, the typical plastic plates or boards includes a less strength such that the typical plastic plates or boards may be easily broken or damaged easily. In order to increase the strength of the typical plastic plates or boards, the materials may be changed or improved to increase the density of the typical plastic plates or boards.

However, when the density of the typical plastic plates or boards is greatly increased, the weight of the typical plastic plates or boards will also be greatly increased, such that the typical plastic plates or boards are not good for manufacturing various objects.

The present invention has arisen to mitigate and/or obviate the afore-described disadvantages of the conventional methods for forming boards of foamable materials.

### SUMMARY OF THE INVENTION

The primary objective of the present invention is to provide a method for forming boards having an intermediate layer of foamable materials, to increase the strength of the boards, and to decrease the weight of the boards.

In accordance with one aspect of the invention, there is provided a method for forming boards of foamable materials, the method comprising providing two plastic materials, heating the plastic materials, providing a foamable material and disposing the foamable material between the plastic materials, heating the foamable material, and squeezing the plastic materials and the foamable material together, to form a board having two outer layers formed by the plastic materials, and an intermediate layer formed by the foamable material.

An air is preferably injected into the foamable material before conducting the squeezing process, in order to decrease the density and the weight of the foamable material and the boards. The air may be selectable from carbon dioxide, propane, or butane, or the like

It is preferable that the plastic materials and the foamable material are cooled after conducting the squeezing process, and may further be cut after conducting the cooling process.

Alternatively, a foamable agent may be filled into the foamable material before conducting the heating process of the foamable material, in order to foam the foamable material, and so as to decrease the density and the weight of the foamable material and the boards.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an object to be manufactured with a method in accordance with the present invention;

FIG. 2 is a partial perspective view of the object manufactured with the method for forming boards of foamable materials;

FIG. 3 is an enlarged partial perspective view of the object as shown in FIG. 1;

FIG. 4 is a partial cross sectional view taken along lines 4-4 of FIG. 2;

FIG. 5 is a flow chart illustrating the procedures of the method for forming boards of foamable materials;

FIG. 6 is a plan schematic view illustrating the squeezing operation of the method for forming boards of foamable materials;

FIG. 7 is a flow chart similar to FIG. 5, illustrating the other procedures of the method for forming boards of foamable materials; and

FIGS. 8, 9, 10, 11 are perspective views illustrating the other objects to be manufactured with the method for forming boards of foamable materials.

### DETAILED DESCRIPTION OF THE PREFERRED EMBODIMENT

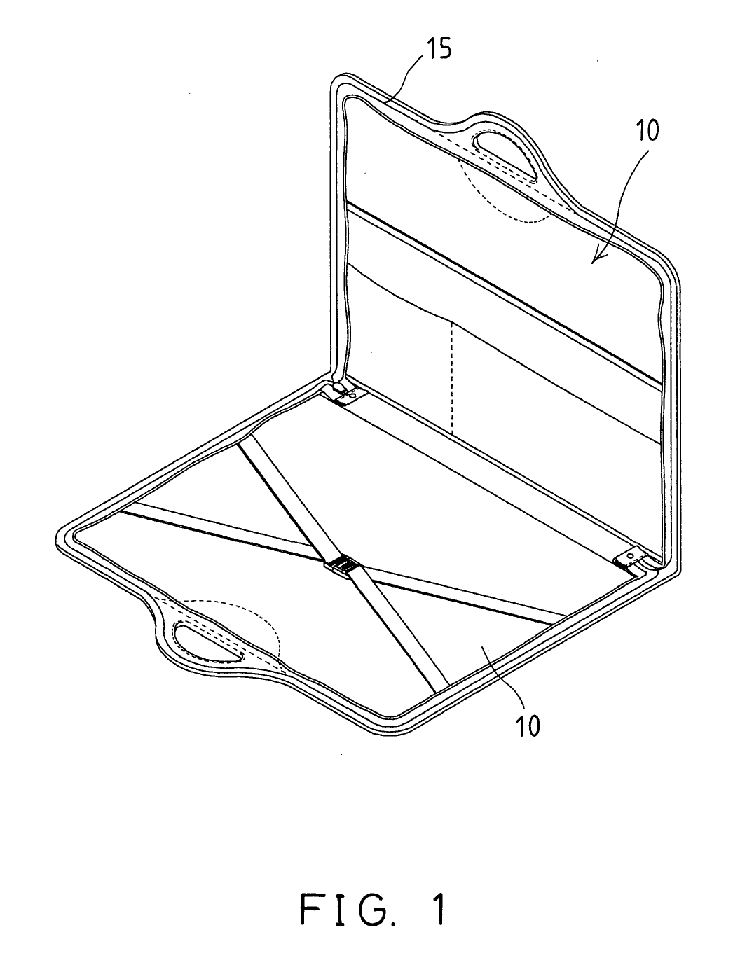

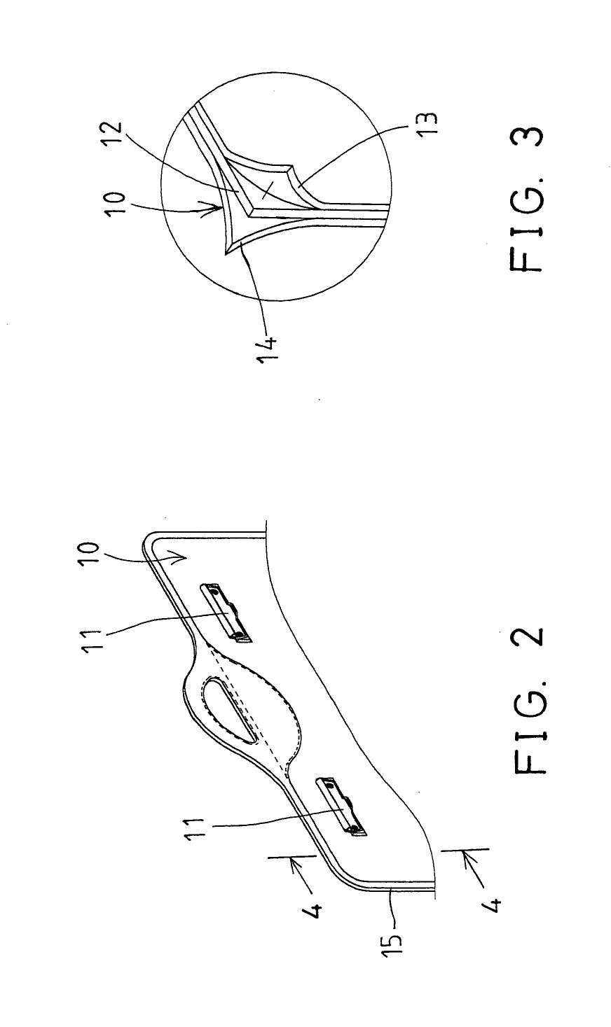

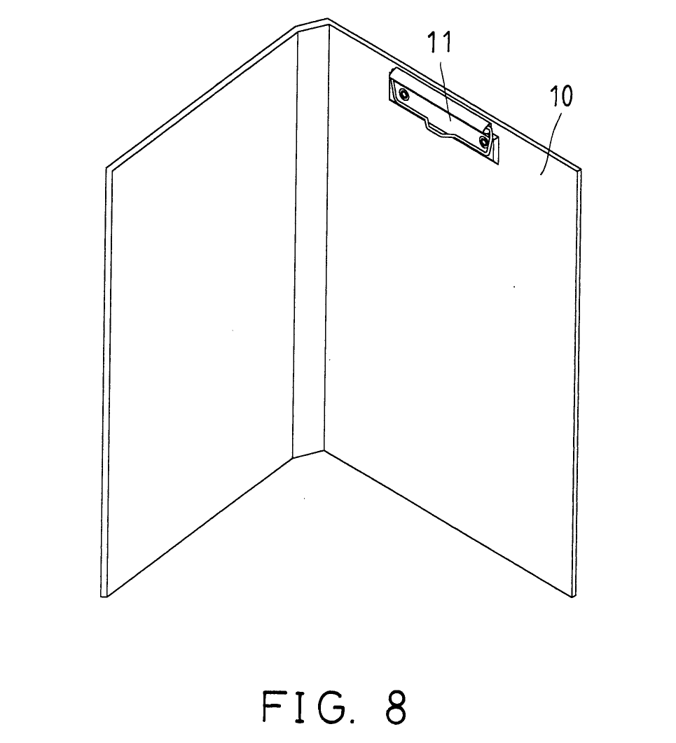

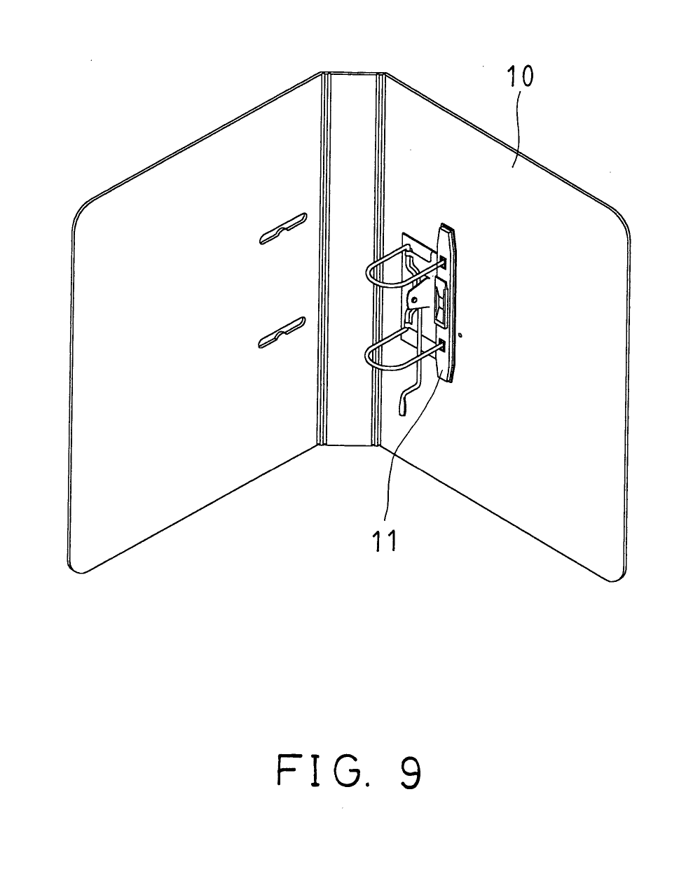

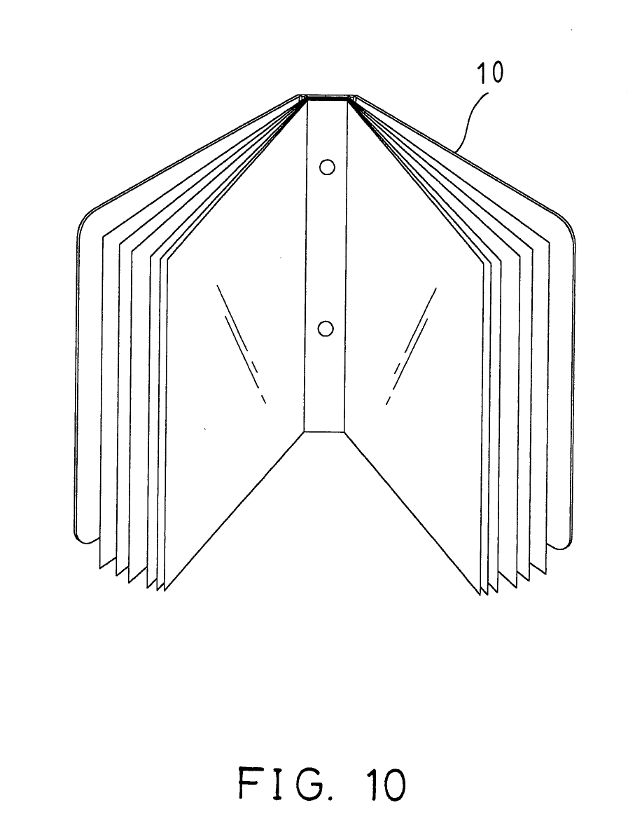

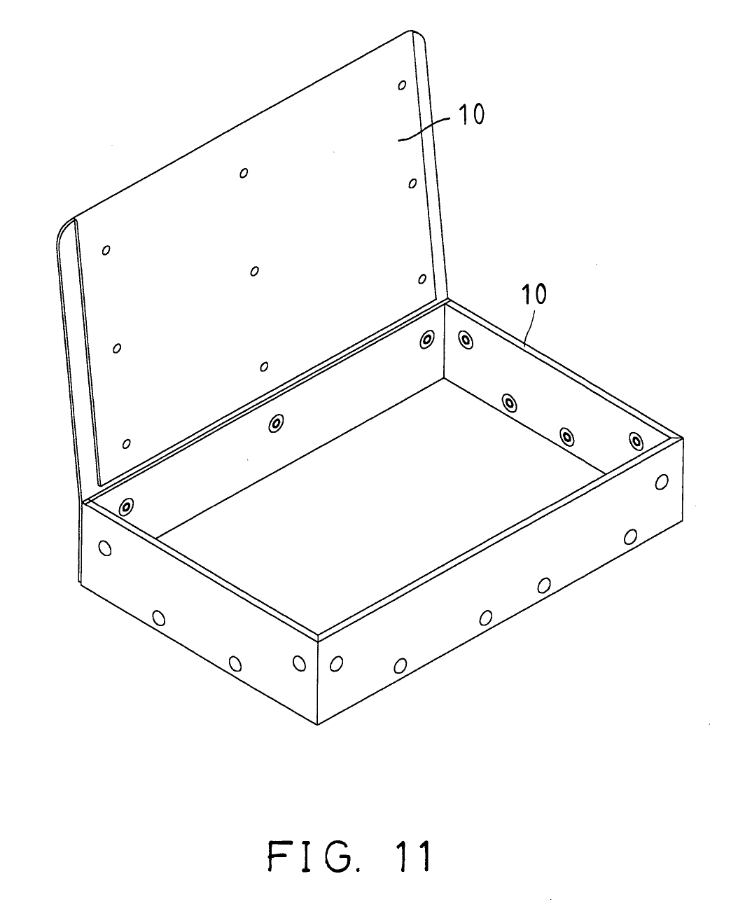

Referring to the drawings, and initially to FIGS. 1-4, a method in accordance with the present invention is provided for forming boards 10 of foamable materials and/or plastic materials that may be used for making various objects, such as the suitcases as shown in FIG. 1, the files as shown in FIGS. 8-10, the casings, or housings, or luggage members, or packaging materials as shown in FIG. 11, etc. The objects may include one or more clips or fasteners 11 attached thereto (FIGS. 2, 8, 9), for securing sheet members therein.

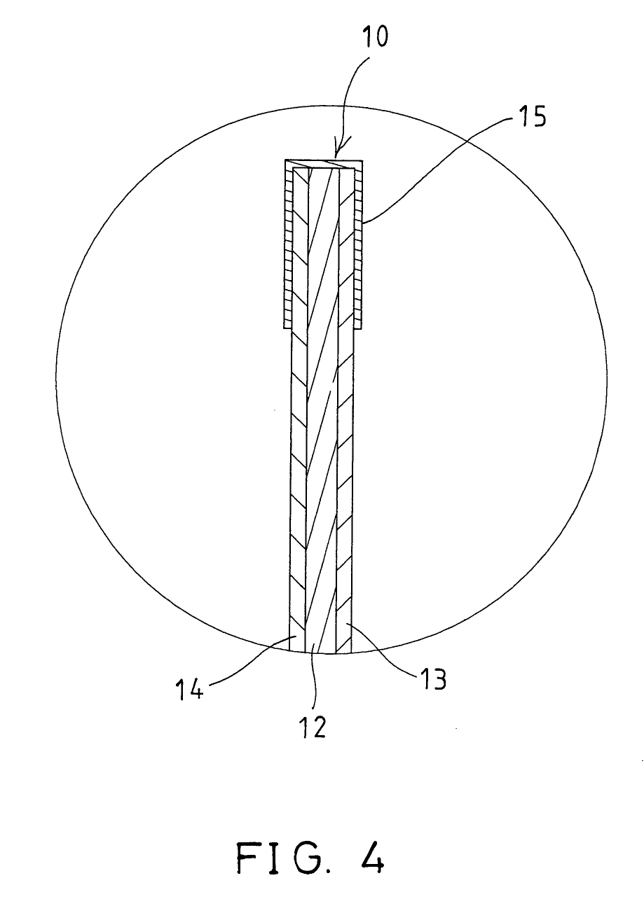

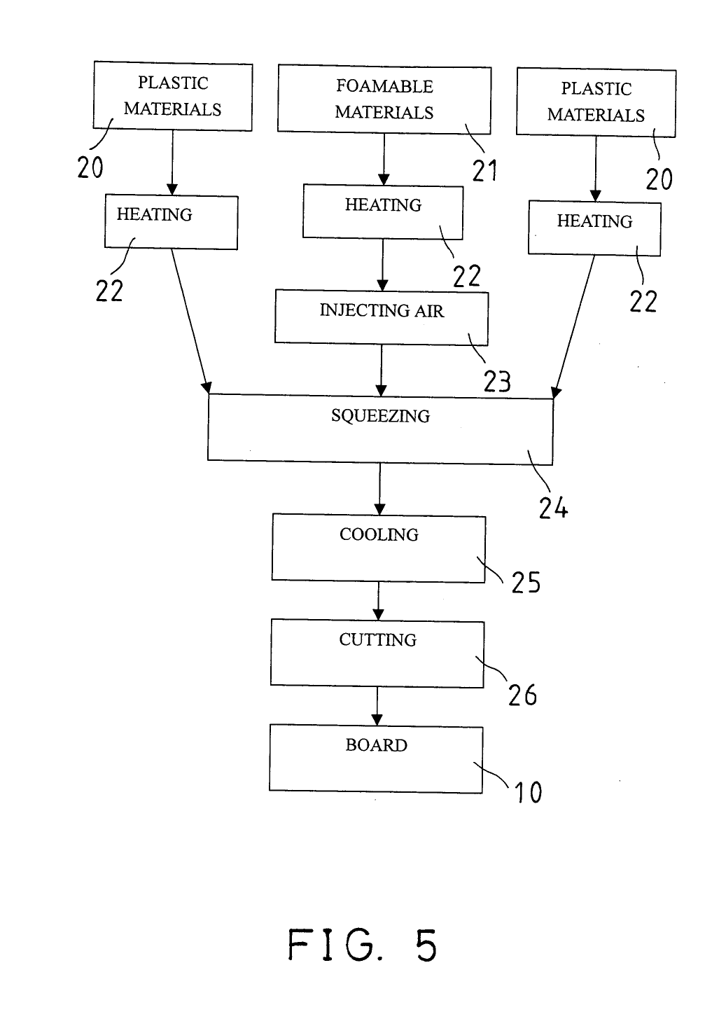

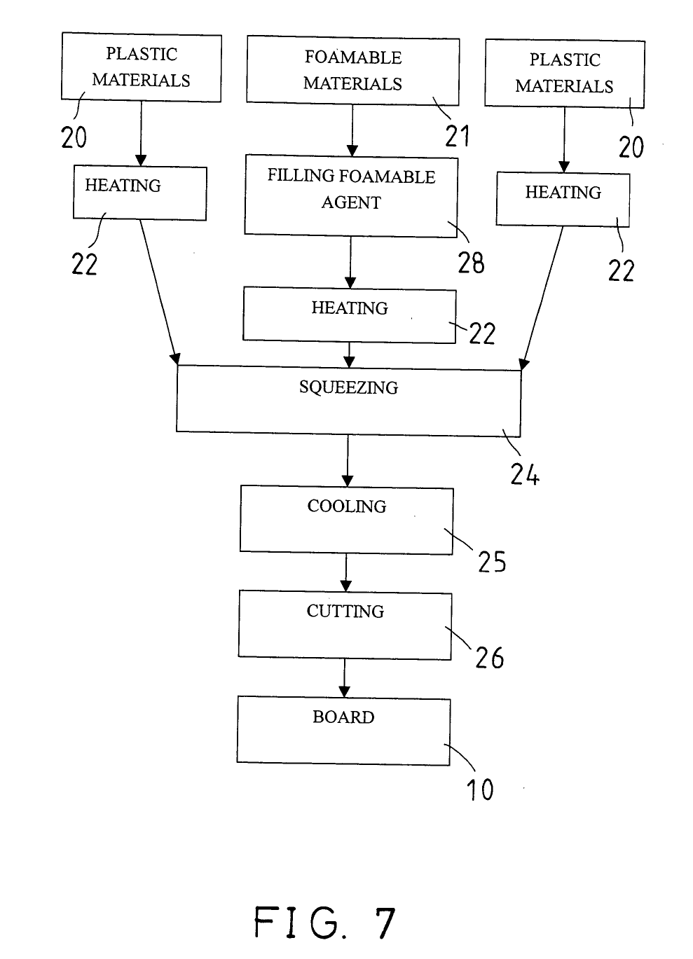

As shown in FIGS. 3 and 4, the board 10 an intermediate layer 12 of foamable materials 21 (FIGS. 5, 7), and two outer layers 13, 14 of plastic materials 20 (FIGS. 5, 7) formed or secured together by such as squeezing processes. A protective rim 15 may be attached to the outer peripheral portion of the board 10, as shown in FIGS. 1, 2 and 4, for protecting the outer peripheral portion of the board 10, and for preventing the outer peripheral portion of the board 10 from being damaged.

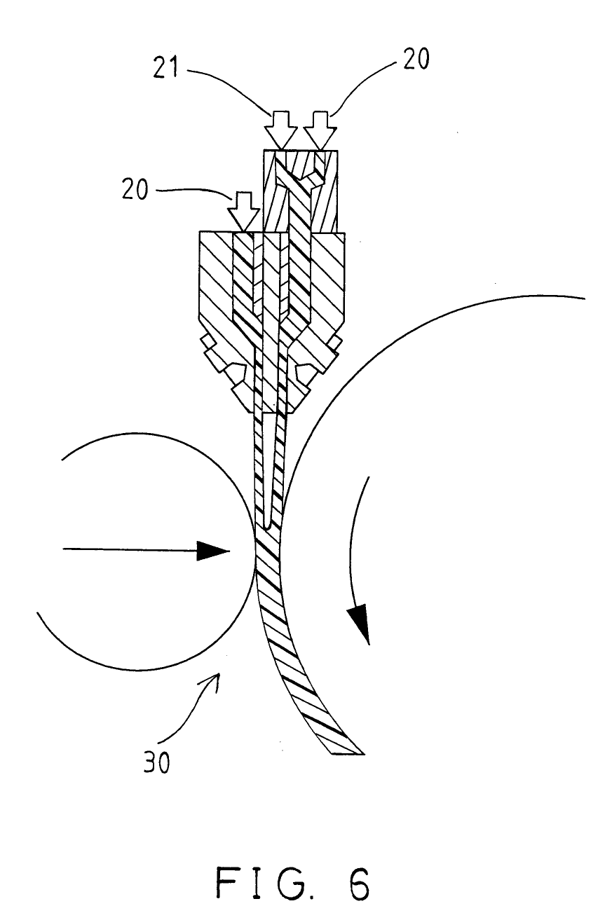

Referring next to FIG. 5, two plastic materials 20 are provided for forming the outer layers 13, 14, and are heated in processes 22 before conducting a squeezing process 24. A foamable material 21 is provided for forming the intermediate layer 12, and is also heated in processes 22 before conducting a squeezing process 24. For example, as shown in FIG. 6, the three materials 20, 21 may be supplied into and squeezed by a squeezing machine 30, an extruding machine, a molding machine or the like.

Referring again to FIG. 5, before the foamable material 21 is subjected to the squeezing process 24, and before or after the foamable material 21 is subjected to the heating process 22, a process 23 is provided to fill or inject an air into the foamable material 21 that is normally in a liquid or pasty like status. The air may be selected from carbon dioxide (CO₂), propane, butane, or the like.

After the squeezing process 24, the squeezed materials 20, 21 will be cooled in process 25, and/or will be trimmed or cut in process 26, in order to form the board 10. It is to be noted that the foamable intermediate layer 12 may be made of waste or recycled plastic or foamable materials, in order to reduce the pollution to the environment, and to protect our environment.

The filling or injecting of the air into the foamable material 21 may decrease the density of the foamable material 21, in order to form the foamable intermediate layer 12 having a density ranging from 0.03 to 0.6 g/cm³. The board 10 may thus have a weight decreasing up to 50 to 95% as compared with that of the typical boards of plastic materials.

Alternatively, as shown in FIG. 7, instead of injecting the air into the liquid or pasty foamable material 21, a foamable agent or a vulcanizing agent may be filled into the foamable material 21 before foamable material 21 is subjected to the squeezing process 24, and/or before the foamable material 21 is subjected to the heating process 22. The foamable intermediate layer 12 thus formed may include a density ranging from 0.5 to 0.8 g/cm³.

It is to be noted that the provision and the engagement of the intermediate foamable materials between the plastic outer layers may increase the strength of the boards 10, and to decrease the weight of the boards. In addition, the intermediate foamable materials may provide a greater resilience or cushioning effect to the boards 10.

Accordingly, the method in accordance with the present invention includes an intermediate layer of foamable materials, to increase the strength of the boards, and to decrease the weight of the boards.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for forming boards of foamable materials, said method comprising:
providing two plastic materials,
heating said plastic materials,
providing a foamable material and disposing said foamable material between said plastic materials,
heating said foamable material, and
squeezing said plastic materials and said foamable material together, to form a board having two outer layers formed by said plastic materials, and an intermediate layer formed by said foamable material.

2. The method as claimed in claim 1 further comprising injecting an air into said foamable material before conducting said squeezing process.

3. The method as claimed in claim 2, wherein said air is selectable from carbon dioxide, propane, or butane.

4. The method as claimed in claim 1 further comprising cooling said plastic materials and said foamable material after conducting said squeezing process.

5. The method as claimed in claim 4 further comprising cutting said plastic materials and said foamable material after conducting said cooling process.

6. The method as claimed in claim 1 further comprising filling a foamable agent into said foamable material before conducting said heating process of said foamable material.
